(19) United States
(12) Patent Application Publication
(10) Pub. No.: US 2011/0194271 A1
(43) Pub. Date: Aug. 11, 2011

(54) LIGHTING DEVICE

(75) Inventors: Marco Van As, Waalre (NL); Wen Gu, Shanghai (CN); Ralph Kurt, Endhoven (NL)

(73) Assignee: KONINKLIJKE PHILIPS ELECTRONICS N.V., EINDHOVEN (NL)

(21) Appl. No.: 13/122,747

(22) PCT Filed: Oct. 2, 2009
(86) PCT No.: PCT/IB09/54309

§ 371 Date: Apr. 6, 2011

(30) Foreign Application Priority Data
Oct. 9, 2008 (EP) 08166197.7

(51) Int. Cl. G03B 15/02

(52) U.S. Cl. 362/11

(57) ABSTRACT

It is presented a lighting device (2) for motion picture recording systems, e.g. television recording systems (1). The lighting device (2) comprises at least three solid state light sources (11-1, 11-2, 11-3, 11-4). At least a first (11-1) of the light sources has a peak emissive wavelength between 415 nm and 435 nm and a spectral width between 0.5 nm and 50 nm.

### TECHNICAL FIELD

The technical field of the present invention is lighting. More specifically, the present invention relates to a lighting device for a motion picture recording system, e.g. a television recording system.

### BACKGROUND OF THE INVENTION

Television (TV) recording cameras can use CCD or CMOS sensors in combination with color filters to record a color image. The combination of sensor characteristics, filters and a process matrix may be optimized for conventional light sources such as sun light or discharge lamps. Due to the nature of the filters, image processing may however be required inside the camera to create an image that is reproducing colors in a natural way. This image processing may however assume a certain light source to be used. Normally it is assumed that a black body radiator, sun or tungsten source is illuminating the object to be recorded. Lighting used in studio environments have traditionally been tungsten, xenon, or other high-pressure discharge lamps with reasonably continuous spectrum.

Nowadays, solid state light (SSL) sources, such as light emitting diodes (LEDs), are becoming increasingly popular in various lighting applications such as e.g. ambient lighting, foods lighting or studio recording lighting. Using LEDs in studio environments may have several advantages. For instance, color tuning and control of color can be made easier and more accurate than for traditional lighting devices used in studios. Therefore, the use of LEDs in a studio environment may be desirable. However, lighting using LED sources is in several aspects different than traditional studio lighting. For example, LED sources normally have different light emission characteristics, such as a more narrow emissive spectra, than the above mentioned widely used traditional lighting devices. Therefore cameras with settings arranged to reproduce optimal colors of an image, illuminated by means of traditional lighting, cannot generally reproduce the same high quality color image in case the studio lighting used are solid state light sources. Thus, the reproduction of LED colors in TV recording cameras may be below an acceptable level. As a consequence, there may be a large discrepancy between what eyes can see in the studio and what is reproduced by a camera.

### SUMMARY OF THE INVENTION

It is with respect to the above considerations and others that the present invention has been made.

In view of the above, it would therefore be desirable to achieve an improved solid state lighting device for a motion picture recording system, such as a digital video recording system, a television recording system and/or a movie recording system. In particular, it would be advantageous to achieve a solid state lighting device enabling enhanced color reproduction in a motion picture recording system.

To better address one or more of these concerns, in a first aspect of the present invention there is provided a lighting device for a motion picture recording system, the lighting device comprising: at least three SSL sources; wherein at least a first of said at least three SSL source has a peak emissive wavelength between 415 nm and 435 nm and a spectral width between 0.5 nm and 50 nm.

The present invention is based on the inventors' realization that, for motion picture recording systems, the at least first of said at least three SSL sources should be selected to have a peak emissive wavelength within the above-mentioned range and a spectral width within the above-mentioned range. The inventors have found that these particular ranges of the at least a first of said at least three SSL source provides for a lighting device with enhanced color reproduction when used in motion picture recording systems utilizing SSL source(s) for illumination. For example, when used in a TV recording system (e.g. construed as a system in a studio environment for television and/or movie production having a (physical) scene and camera equipment for recording at the scene location) the lighting device allows for illuminating the scene such that e.g. a camera may record at the scene location. Beneficially, the invention may be used to provide SSL illumination in a studio environment and enabling enhanced reproduction of colors recorded by a camera. Hence, it should be appreciated that the present invention allows for better compatibility between a motion picture recording system and SSL source(s) when SSL source(s) are used for the illumination.

The inventors have made several important realizations in order to enhance the reproduction of colors when utilizing SSL sources to illuminate e.g. a studio environment. Firstly, they have realized that the tuning of the wavelength of different SSL sources comprised by a lighting device may improve the quality of color reproduction. Secondly, they have realized that wavelengths in the blue spectrum have the most apparent effects on the quality of the reproduced image.

As used herein, spectral width (also known as Full Width at Half Maximum, FWHM) is defined as a part of an emissive spectrum of a light source which has an intensity above half the maximum peak intensity.

In this context, a SSL source is to be understood as any type of semiconductor light source, i.e. a light source using hole-charge recombination techniques, preferably a high power semiconductor light source, suitable for illuminating e.g. a scene in a motion picture recording system, e.g. a TV recording system. SSL sources include but are not limited to LEDs, OLEDs and lasers.

The at least first SSL source may have a peak emissive wavelength at 425 nm. Thereby, on average, less color reproduction errors may be achieved for lighting devices operating between 2000 and 6000K, preferably between about 3000 K and 5000 K.

The at least first SSL source may have a spectral width (i.e. FWHM) between 10 nm and 45 nm, more preferably between 15 nm and 40 nm, most preferably between 20 nm and 30 nm.

The at least first SSL source may advantageously have a spectral width of about 25 nm.

At least a second SSL source of said at least three SSL sources may have a peak emissive wavelength between 592 nm and 606 nm.

At least a third SSL source of said at least three SSL sources may have a peak emissive wavelength between 526 nm and 538 nm.

The at least second SSL source may advantageously have a 600 nm peak emissive wave length. Alternatively, the at least second SSL source may have a peak emissive wavelength between 610 nm and 670 nm.

The at least third SSL sources may have a peak emissive wavelength of about 530 nm.

At least one of said at least three SSL sources may comprise an LED.

In an embodiment, the at least three SSL sources may be direct emitters, i.e. ‘regular’ SSL devices, in contrast to e.g. a phosphor pumped LED, i.e. a phosphor converted LED. According to another embodiment of the invention, at least one of the SSL sources may comprise a phosphor converted light source, and the light emitted by the SSL source is at least partially phosphor converted light. In yet another particular embodiment said phosphor is a lumiramic tile.

An embodiment may further comprise at least one white light SSL source.

At least one of the at least three SSL sources may comprise a laser diode. Thereby, since lasers typically have a higher brightness (i.e. more light intensity per emitting surface), a more compact optical system may be utilized, especially for light project systems.

The laser diode may have a peak emissive wavelength in the range of 415-435 nm, preferably about 425 nm.

A color temperature of the at least three SSL sources may be 3000 K.

A color temperature of the at least three SSL sources may be 5000 K.

According to a second aspect of the invention, there is provided a motion picture recording system comprising the lighting device according to the first aspect. The motion picture recording system may e.g. be a digital video recording system, a television recording system and/or a movie recording system.

Generally, this second aspect may exhibit the same advantages and features as the first aspect.

These and other aspects of the invention will be apparent from and elucidated with reference to the embodiments described hereinafter.

Generally, all terms used herein are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise.

### BRIEF DESCRIPTION OF THE DRAWINGS

Embodiments of the present invention will now be described in more detail, reference being made to the enclosed drawings, in which:

FIG. 1 shows a block diagram of a motion picture recording system.

FIG. 2 shows a schematic view of a lighting device according to an embodiment of the invention.

FIG. 3 shows a schematic view of an embodiment of the lighting device in FIG. 2.

FIG. 4 shows a schematic view of a Greta Macbeth color check pattern.

FIG. 5 shows a schematic view of the motion picture recording system in FIG. 1.

FIG. 6 illustrates a way to measure color reproduction in a camera.

### DETAILED DESCRIPTION OF EMBODIMENTS

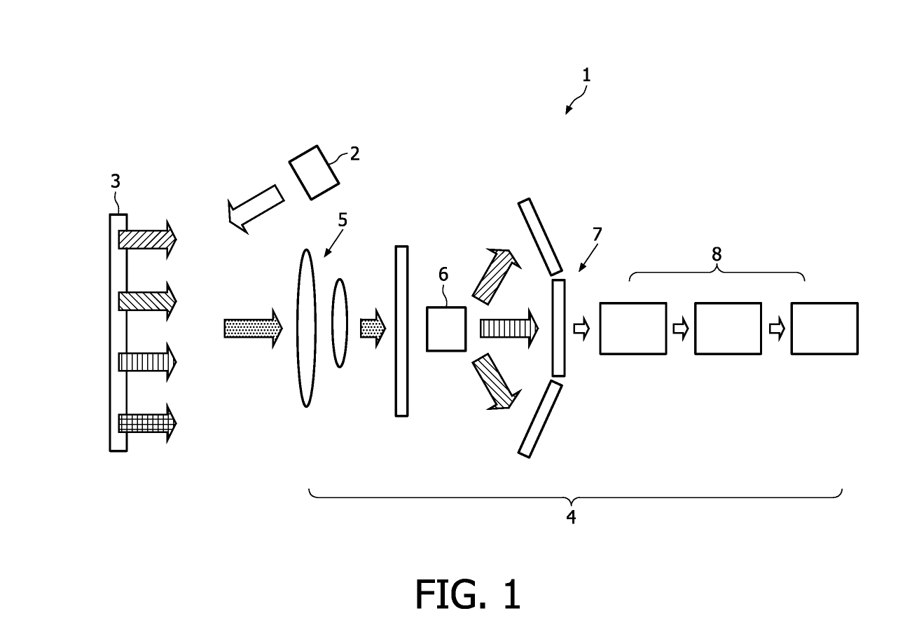

FIG. 1 shows a block diagram of a motion picture recording system 1, such as a television recording system. In this example, the lighting device 2 illuminates a scene 3, which in turn reflects light, which can be captured by a set of optical lenses 5 of a camera 4. The optical lenses 5 may have little effect on changing the spectrum of the light, at least if the camera 4 is well-designed. Inside the camera 4, light is further transmitted through an IR-filter 5. A color filter 6 may separate red, green and blue components of the incident light.

Sensors 7 can detect the red, green and blue light components and relay the detected light components to a processor 8 for processing of the light, the processing involving e.g. gamma correction and white balancing.

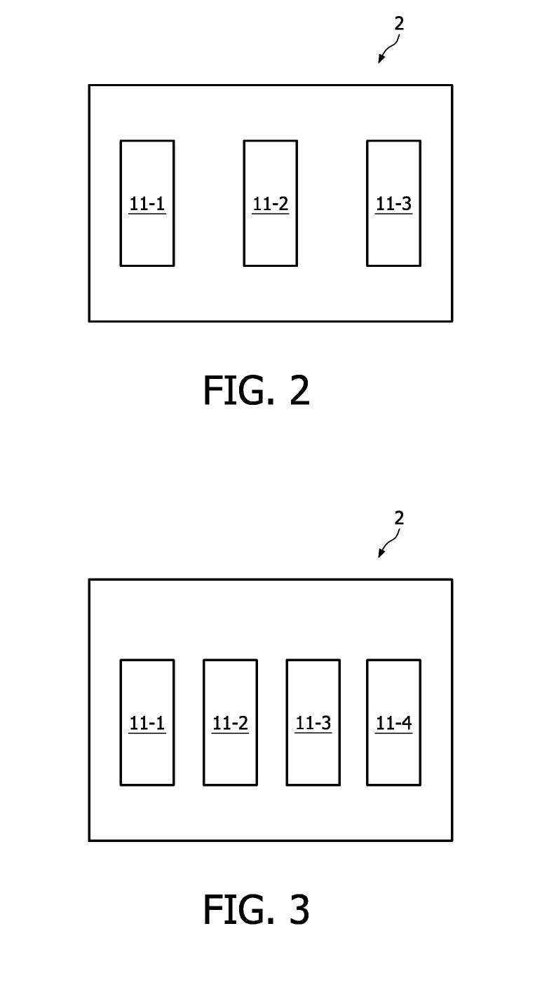

FIG. 2 shows a schematic view of a lighting device 2 according to an embodiment of the invention. The lighting device 2 comprises SSL sources 11-1 to 11-3. The SSL sources 11-1 to 11-3 may for instance comprise LEDs, each comprising one or more LED. Alternatively, at least one of the SSL sources 11-1 to 11-3 can be a solid state laser, such as a diode laser. In an embodiment, the SSL sources 11-1 to 11-3 can be lasers, while the SSL source 11-4 (shown in FIG. 3) can be a white light emitting LED. Preferably, an embodiment comprising the SSL sources 11-1 to 11-4 may encompass a combination of LEDs and solid state lasers for the SSL sources 11-1 to 11-3.

The emissive wavelength of a first SSL source 11-1 of the SSL sources 11-1 to 11-4 can be between 415 and 435 nm, providing a color in the blue spectrum. The spectral width of the first SSL source 11-1 can be between 0.5 nm and 50 nm, preferably between 15 nm and 50 nm. The spectral width of the first SSL source can e.g. be 25 nm. In an embodiment, the peak emissive wavelength of the first SSL source 11-1 can be 425 nm. In an embodiment when the first SSL source 11-1 is a (blue) laser, the spectral width can be around 0.5 nm. Advantageously, the peak emissive wavelength for the laser can be between 415 nm and 435 nm, preferably with a peak emissive wavelength of 425 nm.

A second SSL source 11-2 can in an embodiment have a peak emissive wavelength between 592 nm and 606 nm. In an embodiment, the peak emissive wavelength of the second SSL source 11-2 can be 600 nm.

A third SSL source 11-3 can in an embodiment have a peak emissive wavelength between 526 nm and 538 nm. In an embodiment, the peak emissive wavelength of the second SSL source 11-2 can be 530 nm.

Advantageously, each of the SSL sources 11-1 to 11-4 can be individually tuneable, i.e. their color output may be tuned for the purpose to enable use of a wide variety of cameras with different camera settings. Beneficially, an embodiment can comprise the first SSL source 11-1 having a peak emissive wavelength of 425 nm, the second SSL source 11-2 having a peak emissive wavelength of 600 nm, and the third SSL source 11-3 having a peak emissive wavelength of 530 nm.

In any embodiment, the color temperature, or more particularly, the correlated color temperature, of the lighting device 2 can be 3000 K (Kelvin) or 5000 K.

Due to the relative difficulty to achieve a high power LED with a 600 nm peak emissive wavelength, in an embodiment, a 590 nm phosphor pumped (amber) LED may be used as a second SSL source 11-2, emitting a peak wavelength slightly longer than the specified peak wavelength of the 590 nm amber LED. Advantageously, the correlated color temperature of the lighting device 2 is 5000 K when using a phosphor pumped amber LED, i.e. a phosphor converted LED.

It is envisaged that an embodiment comprises the first SSL source 11-1 with a peak emissive spectrum of 430 nm, the second SSL source 11-2 with a peak emissive spectrum of 614 nm, and the third SSL source 11-3 with a peak emissive spectrum of 550 nm. Preferably, the SSL sources 11-1 to 11-3 in this embodiment comprise LEDs.

FIG. 3 shows a schematic view of an embodiment of the lighting device 2 in FIG. 2. In addition to the SSL sources 11-1 to 11-3, the illustrated embodiment comprises the white SSL source 11-4, thereby forming a RGB+W (abbreviation of Red Green Blue+White) lighting device 2. The SSL sources 11-1 to 11-3 may be any combination of the types described with reference to FIG. 2. Advantageously, the white SSL source 11-4 is an LED. The white SSL source 11-4 may for instance comprise a phosphor converted light source, preferably a remote phosphor such as Philips Lumileds Lumiramic™ phosphor technology. In an embodiment, the first SSL source 11-1 can have a 472 nm peak emissive spectra. The second SSL source 11-2 may have a peak emissive spectra of 615 nm, and the third SSL source 11-3 may have a peak emissive spectra of 532 nm. The white SSL source 11-4 may have a correlated color temperature of 4100 K.

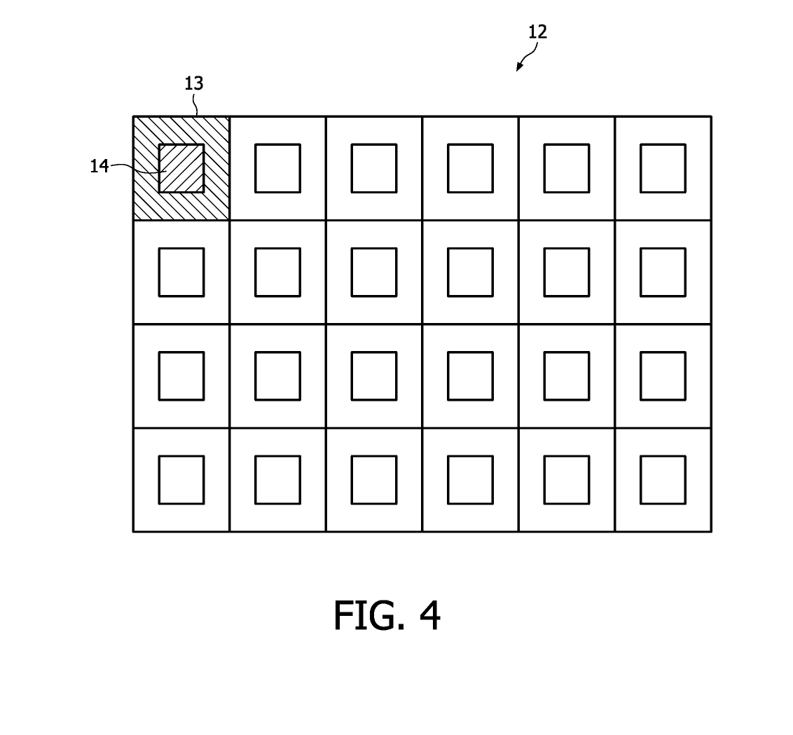

FIG. 4 shows a schematic view of a so-called Greta Macbeth color check pattern 12. The Greta Macbeth color check pattern 12, hereinafter referred to as GMB 12, can be used as a measure to compare the color reproduction in the camera 4. An inner rectangle 14 shows a reproduced color of the original color of an outer rectangle 13. The outer colors can for instance simulate a studio environment in the sense that a studio environment comprises a plurality of colors, which when illuminated, are reflected to the optical lenses 5 of the camera 4 and thereafter processed by the camera 4 as described with reference to FIG. 1.

In this example, as can be seen in FIG. 4, there is a discrepancy between the inner rectangle 13 and the outer rectangle 14. This illustrates the example when color reproduction of the camera 4 is bad. In ideal lighting conditions and an ideal camera, there would be no color discrepancy. In reality, a Greta Macbeth comprises 18 different colors and 6 grayscales, but for simplicity, in this example for the purpose to illustrate the principles of the Greta Macbeth, only one pair of inner/outer rectangles (inner rectangle 14 and outer rectangle 13) of GMB 12 shows different ‘colors’ by means of parallel lines in different directions. This illustrates the color discrepancy.

In order to deduce the specific wavelength intervals and peak emissive wavelengths of the solid state light sources, an advanced mathematical model has been developed by the inventors in MathCAD and used to find a minimal color reproduction error, i.e. a minimal color discrepancy between the inner rectangle 14 and the outer rectangle 13. The inventors have created a mathematical model of the camera 4 in order to obtain a scientific measure of how well different wavelength combinations of SSL sources 11-1 to 11-4 of the lighting device 2 used for lighting reproduce the colors of the scene 2 of the motion picture recording system, which scene in this case is simulated by GMB 12.

In order to get a numerical measure of color discrepancy, i.e. a difference between a scene color and camera reproduced color, color spaces such as CIE XYZ and LUV spaces can be used.

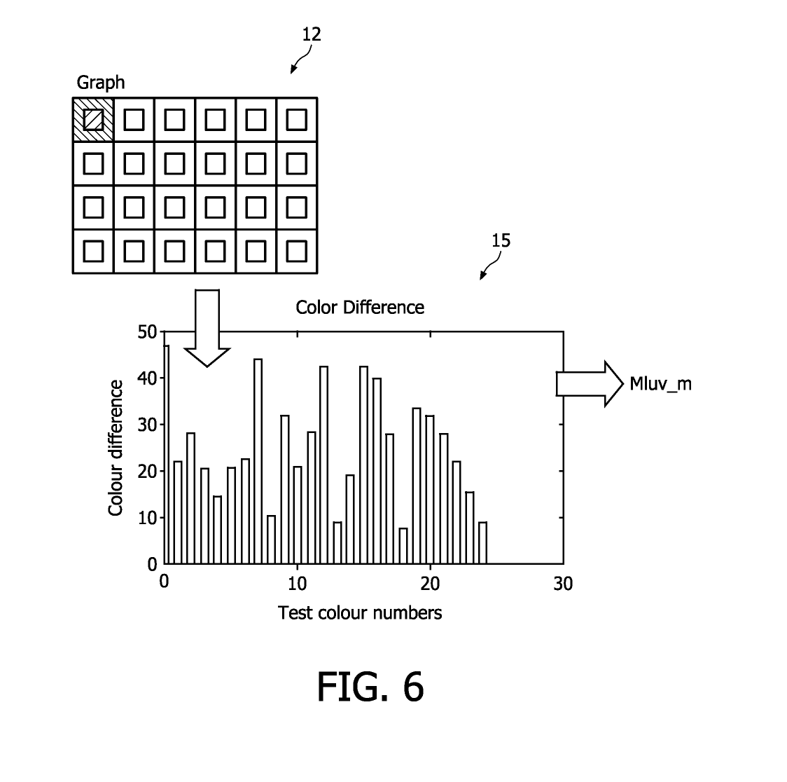

The Euclidean norm in the LUV space can be used to determine a distance between a reference color (the outer rectangle 13), and a reproduced color (the inner rectangle 14) when each color tone has a numerical value attached to it in the LUV space, for each of the 24 fields of the GMB 12. This gives rise to 24 values as shown in the diagram 15 of FIG. 6.

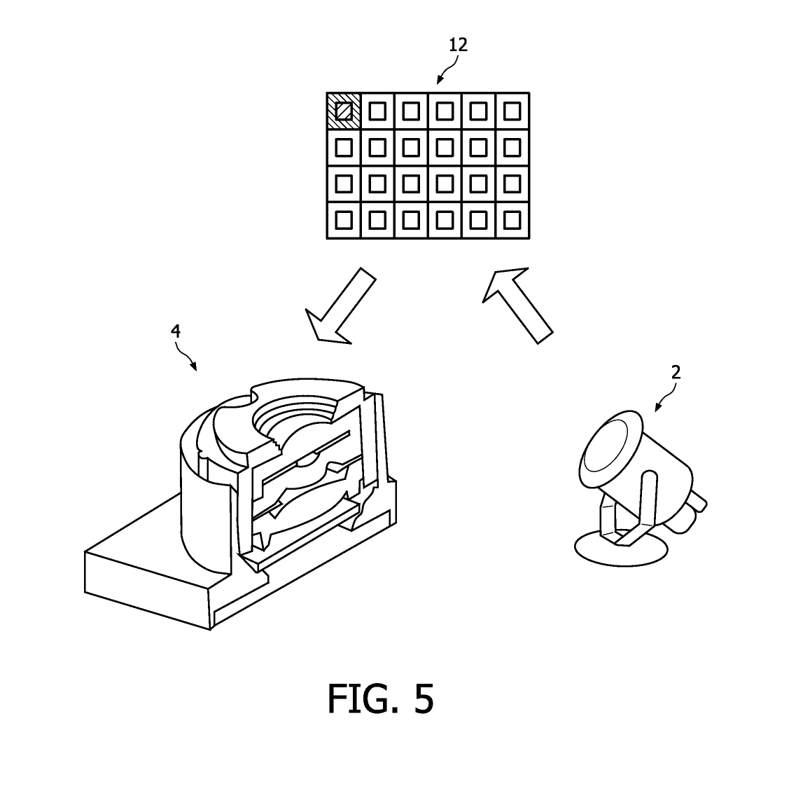

FIG. 5 shows a schematic view of the motion picture recording system in FIG. 1. In this example, the scene 3 has been replaced by the GMB 12, which simulates the colors of the scene 3.

FIG. 6 illustrates a way to measure color reproduction in the camera 4. Each column in the diagram 15 illustrates the norm difference in the LUV space, as described above. In order to achieve a more general measure, or effect of reproduction of colors of all the 18 colors and 6 grayscales, the average of the sum of all columns can be calculated, providing a single measure, Mluv_m, of the color reproduction of the camera 4. One can categorize the reproduction quality for instance by letting:

the range 0-5 stand for excellent reproduction, difficult to tell difference in a Greta Macbeth,

the range 6-8 stand for ok for studio, although difference may be noticed,

the range 8-10 stand for the maximum limit of acceptable reproduction for an observer, and

10 and above stand for bad color reproduction.

Indeed, the color reproduction of SSL sources may in fact be very bad if SSL sources are not tuned very carefully and if arbitrary RGB colors are utilized. It is not unusual to reach Mluv_m values in the range of 60-70, which correspond to terrible color reproduction, even with relatively small deviations from the wavelength ranges and combinations defined in this specification.

On the other hand, the combination of the first SSL source 11-1 with peak emissive wavelength at 425 nm, the second SSL source 11-2 with peak emissive wavelength at 530 nm, the third SSL source 11-3 with peak emissive wavelength at 600 nm, gives an acceptable Mluv_m value just below 7 for the lighting device 2 with a correlated color temperature of 3000 K. For a correlated color temperature of 5000 K, the same value is slightly higher, but still below 7.

Simulations and analysis of Mluv_m values have also shown that the first SSL source 11-1, i.e. the SSL source emitting within the blue spectrum of visible light, has the largest impact on the color reproduction in the camera 4. A peak emissive wavelength of 427 nm of the first SSL source 11-1 gives an Mluv_m value below 6 for the lighting device 2 with a correlated color temperature of 3000 K. On the other hand, with a correlated color temperature of 5000 K, the best Mluv_m value is reached with a peak emissive wavelength of 424 nm for the first SSL source 11-1, reaching an Mluv_m value at around 6.5. By calculating the mean of the 3000 K and 5000 K results, the best result for both correlated color temperatures, as described above, with a 425 nm peak emissive wavelength for the first SSL source 11-1, was determined. It was also found by the inventors that by slightly altering the peak emissive wavelength of the second SSL source 11-2 around 600 nm, and altering the peak emissive wavelength of the third SSL source 11-3 around 530 nm, the Mluv_m value changed considerably less than for the first SSL source 11-1 when altered around 425 nm.

It is envisaged that a combination of the lighting device 2 and traditional light sources, such as tungsten or xenon discharge lamps, can be used in studio environments. Such combinations may provide the advantages of SSL technology combined with the benefits of traditional lighting, such as present cameras being adapted to reproduce colors when traditional studio lighting is used.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. The mere fact that certain measures are recited in mutually different dependent claims does not indicate that a combination of these measured cannot be used to advantage. Furthermore, any reference signs in the claims should not be construed as limiting the scope.

1. A lighting device for a motion picture recording system, the lighting device comprising:
at least three Solid State Lighting (SSL) sources, wherein at least a first of said at least three SSL sources has a peak emissive wavelength within a blue spectrum and a spectral width between 0.5 nm and 50 nm, wherein the SSL sources are individually tunable such that a wavelength combination from said at least three SSL sources is selected to reproduce the colors of a scene captured by the motion picture recording system.

2. The lighting device according to claim 18, wherein said at least first SSL source has a peak emissive wavelength at 425 nm.

3. The lighting device according to claim 1, wherein said at least first SSL source has a spectral width between 10 nm and 45 nm.

4. The lighting device according to claim 3, wherein said at least first SSL source has a spectral width of 25 nm.

5. The lighting device according to claim 1, wherein at least a second SSL source of said at least three SSL sources has a peak emissive wavelength between 592 nm and 606 nm.

6. The lighting device according to claim 1, wherein at least a third SSL source of said at least three SSL sources has a peak emissive wavelength between 526 nm and 538 nm.

7. The lighting device according to claim 5, wherein said at least second SSL source has a 600 nm peak emissive wave length.

8. The lighting device according to claim 6, wherein said at least third SSL source has a peak emissive wavelength of 530 nm.

9. The lighting device according to claim 1, wherein at least one of said at least three SSL sources comprises an LED or a laser diode.

10. The lighting device according to claim 9, wherein said LED comprises a phosphor converted light source.

11. The lighting device according to claim 1, further comprising at least one white light SSL source.

12. (canceled)

13. The lighting device according to claim 9, wherein said laser diode has a peak emissive wavelength in the range of 415-435 nm.

14. The lighting device according to claim 1, wherein a color temperature of said at least three SSL sources is 3000 K.

15. The lighting device according to claim 1, wherein a color temperature of said at least three SSL sources is 5000 K.

16. (canceled)

17. The lighting device according to claim 1, wherein the SSL sources are tunable in accordance with a camera setting of a camera of the motion picture recording system.

18. The lighting device according to claim 1, wherein said at least first SSL source has a peak emissive wavelength between 415 nm and 435 nm.
